(19) United States
(12) Patent Application Publication
(10) Pub. No.: US 2025/0076464 A1
(43) Pub. Date: Mar. 6, 2025

(54) Apparatus For Recognizing Object And Method Thereof

(71) Applicants: Hyundai Motor Company, Seoul (KR); Kia Corporation, Seoul (KR)

(72) Inventor: En Sun Lee, Seoul (KR)

(21) Appl. No.: 18/607,824

(22) Filed: Mar. 18, 2024

(30) Foreign Application Priority Data
Sep. 4, 2023 (KR) 10-2023-0117175

(51) Int. Cl. G01S 7/48; G06T 7/13; G06T 7/246; G06T 7/73

(52) U.S. Cl. CPC G01S 7/4802; G06T 7/13; G06T 7/248; G06T 7/74; G06T 2207/10028; G06T 2207/30252

(57) ABSTRACT

An apparatus may comprise a sensor, and a processor configured to determine points identified in a frame associated with an object, determine: whether the object is absent in a first frame before the frame, whether all or part of the points are unobstructed, and whether a moved distance of the object between the frame and a second frame after the frame is greater than a threshold distance, or whether a speed of the object is greater than a threshold speed, assign a reliability value to the object based on at least one of a minimum value of first axis coordinates of the points and a maximum value of first axis coordinates of the points being within the range, or based on at least one of the aforementioned determinations, determine that the object is moving or movable, and output a signal indicating that the object is moving or movable.

### CROSS-REFERENCE TO RELATED APPLICATION

This application claims the benefit of priority to Korean Patent Application No. 10-2023-0117175, filed in the Korean Intellectual Property Office on Sep. 4, 2023, the entire contents of which are incorporated herein by reference.

### TECHNICAL FIELD

The present disclosure relates to an object recognition apparatus and method, and more particularly, to a technique for determining characteristics of an object based on positions of contour points obtained through a sensor (e.g., a light detection and ranging (LIDAR)).

### BACKGROUND

An autonomous vehicle or a vehicle with an activated driver assistance device may detect a surrounding environment and an obstacle through a sensor to protect a driver and determine a route. In particular, research is being continuously conducted to determine surrounding objects through a sensor (e.g., LIDAR) as the accuracy of data obtained through the LIDAR is higher than that of data obtained through a radar.

A vehicle may obtain data indicating the position of an object around the vehicle through a LIDAR. A distance from a LIDAR to an object may be obtained through an interval between the time when laser is transmitted by the LIDAR and the time if the laser reflected by the object is received. A vehicle is able to determine the position of a point included in the outside of the object in a space where the vehicle is located, based on the angle of the transmitted laser and the distance to the object.

Based on the movement information of acquired points, the autonomous vehicle or the vehicle with an activated driver assistance device may determine the information of an object represented by the points. In particular, technology to determine whether an object is moving, movable, or non-movable (e.g., a moving object, an object capable of being in a moving state, or an object incapable of being in a moving state) may be useful to ensure the stability of autonomous driving or driver assistance driving and reduce the risk of accidents.

### SUMMARY

According to the present disclosure, an apparatus may comprise: a sensor, and a processor, wherein the processor is configured to: determine contour points identified in a plane in a specific frame and included in an object box representing an object, wherein the plane is formed by a first axis and a second axis, the first axis corresponding to a moving direction of the sensor, and the second axis being perpendicular to the first axis, determine whether a minimum value of first axis coordinates of the contour points is within a range, or whether a maximum value of the first axis coordinates of the contour points is within the range, determine whether the object is absent in a first frame before the specific frame, determine whether all or part of the contour points are unobstructed by another object different from the object, determine whether a moved distance of the object between the specific frame and a second frame after the specific frame is greater than a specified distance, or whether a speed of the object is greater than a specified speed, assign a reliability value to the object based on at least one of: the minimum value of the first axis coordinates and the maximum value of the first axis coordinates being within the range, the object being absent in the first frame, all or part of the contour points being unobstructed by the another object, the moved distance being greater than the specified distance, or the speed being greater than the specified speed, and determine, based on the reliability value, that the object is moving or movable, and output a signal indicating that the object is moving or movable.

The apparatus, wherein the processor is configured to: determine whether the minimum value of the first axis coordinates is within the range, and determine whether the maximum value of the first axis coordinates is within the range based on a determination that the minimum value of the first axis coordinates is within the range.

The apparatus, wherein the processor is configured to: assign, to the object, a first boundary object feature value that is a specified value to the object in the specific frame, based on the minimum value of the first axis coordinates being within the range, assign, to the object, a second boundary object feature value that is the specified value to the object in the second frame, based on the object being absent in the first frame and the maximum value of the first axis coordinates being within the range, assign, to the object, the second boundary object feature value assigned to the object in the first frame based on: the assigned first boundary object feature value being the specified value, the object existing in the first frame, or the maximum value of the first axis coordinates not falling within the range, and assign the reliability value to the object included in the specific frame, based on at least one of: the first boundary object feature value assigned to the object in the specific frame and the second boundary object feature value assigned to the object in the specific frame being the specified value, all or part of contour points being unobstructed by another object, the moved distance being greater than the specified distance, or the speed of the object being greater than a specified speed.

The apparatus, wherein the processor is configured to: determine a relative moved distance of the object with respect to a vehicle based on a difference between a position of a point corresponding to the object in the specific frame and a position of a point corresponding to the object in the second frame, determine the moved distance based on a sum of a moved distance of the vehicle and the relative moved distance of the object, and match the point corresponding to the object in the specific frame to the point corresponding to the object in the second frame.

The apparatus, wherein the processor is configured to: determine a center point contained in a most preceding line segment in a moving direction of the object among line segments constituting the object box as a point corresponding to the object, or determine another point contained in the most preceding line segment as the point corresponding to the object.

The apparatus, wherein values, of the first axis coordinates of points included in the range, are included between: a value of a first axis coordinate of a point corresponding to a vehicle and a value of a second axis coordinate separated from the first axis coordinate of the point corresponding to the vehicle by a threshold distance in a direction of the first axis.

The apparatus, wherein the processor is configured to: determine that a second axis coordinate of a point corresponding to the object is within a second axis range, and assign a second reliability value to the object based on at least one of: the second axis coordinate being within the second axis range, at least one of the minimum value of the first axis coordinates and the maximum value of the first axis coordinates being within the range, the object being absent in the first frame, all or part of the contour points being unobstructed by the another object, the moved distance being greater than the specified distance, or the speed of the object being greater than the specified speed.

The apparatus, wherein the processor is configured to: determine whether a second axis coordinate of a point corresponding to the object is located in a second axis range including a specified number of lanes on both sides of a lane where a vehicle is located, and assign the reliability value to the object based on the second axis coordinate of the point corresponding to the object being located in the second axis range.

The apparatus, wherein the processor is configured to assign, to the object, an identifier indicating that the object is moving or movable, based on determining that the object is moving or movable.

The apparatus, wherein the specified speed indicates a threshold value for determining whether the object is moving or movable, based on a minimum first axis coordinate value of the object or a maximum first axis coordinate value of the object being included in the range, and wherein values of the first axis coordinates of points included in the range are included between: a value of a first axis coordinate of a point corresponding to a vehicle and a value of a second axis coordinate separated from the first axis coordinate of the point corresponding to the vehicle by a threshold distance in a direction of the first axis.

According to the present disclosure, a method performed by a processor, the method may comprise: determining contour points identified in a plane in a specific frame and included object box representing an object, wherein the plane is formed by a first axis and a second axis, the first axis corresponding to a moving direction of a sensor, and the second axis being perpendicular to the first axis, determining whether a minimum value of first axis coordinates of the contour points is within a range or whether a maximum value of the first axis coordinates of the contour points is within the range, determining whether the object is absent in a first frame before the specific frame, determining whether all or part of the contour points are unobstructed by another object different from the object, determining whether a moved distance of the object between the specific frame and a second frame after the specific frame is greater than a specified distance or whether a speed of the object is greater than a specified speed, assigning a reliability value to the object based on at least one of: the minimum value of the first axis coordinates and the maximum value of the first axis coordinates being within the range, the object being absent in the first frame, all or part of the contour points being unobstructed by the another object, the moved distance being greater than the specified distance, or the speed being greater than the specified speed, determining, based on the reliability value, that the object is moving or movable, and outputting a signal indicating that the object is moving or movable.

The method, wherein the determining whether the minimum value is within the range or whether the maximum value is within the range includes: determining whether the minimum value of the first axis coordinates is within the range, and determining whether the maximum value of the first axis coordinates is within the range based on determining that the minimum value of the first axis coordinates is within the range.

The method, may further comprise: assigning, to the object, a first boundary object feature value that is a specified value to the object in the specific frame, based on the minimum value of the first axis coordinates being within the range, assigning, to the object, a second boundary object feature value that is a specified value to the object in the second frame, based on the object being absent in the first frame and the maximum value of the first axis coordinates being within the range, assigning, to the object, the second boundary object feature value assigned to the object in the first frame based on: the assigned first boundary object feature value being the specified value, the object existing in the first frame, or the maximum value of the first axis coordinates not being with the range, and assigning the reliability value to the object included in the specific frame, based on at least one of: the first boundary object feature value assigned to the object in the specific frame and the second boundary object feature value assigned to the object in the specific frame being the specified value, all or part of contour points being unobstructed by another object, the moved distance being greater than the specified distance, or the speed of the object being greater than a specified speed.

The method, wherein the determining whether the moved distance of the object between the specific frame and the second frame after the specific frame is greater than the specified distance or whether the speed of the object is greater than the specified speed includes: determining a relative moved distance of the object with respect to a vehicle based on a difference between a position of a point corresponding to the object in the specific frame and a position of a point corresponding to the object in the second frame, determining the moved distance based on a sum of a moved distance of the vehicle and the relative moved distance of the object, and matching the point corresponding to the object in the specific frame to the point corresponding to the object in the second frame.

The method, wherein the determining whether the moved distance of the object between the specific frame and the second frame after the specific frame is greater than the specified distance or whether the speed of the object is greater than the specified speed includes: determining a center point contained in a most preceding line segment in a moving direction of the object among line segments constituting the object box as a point corresponding to the object, or determining another point contained in the most preceding line segment as the point corresponding to the object.

The method, wherein values, of the first axis coordinates of points included in the range, are included between: a value of a first axis coordinate of a point corresponding to a vehicle and a value of a second axis coordinate separated from the first axis coordinate of the point corresponding to the vehicle by a threshold distance in a direction of the first axis.

The method, may further comprise: determining that a second axis coordinate of a point corresponding to the object is within a second axis range, and assigning a second reliability value to the object based on at least one of: the second axis coordinate being within the second axis range, at least one of the minimum value of the first axis coordinates and the maximum value of the first axis coordinates being within the range, the object being absent in the first frame, all or part of the contour points being unobstructed by the another object, the moved distance being greater than the specified distance, or the speed of the object being greater than the specified speed.

The method, may further comprise: determining whether a second axis coordinate of a point corresponding to the object is located in a second axis range including a specified number of lanes on both sides of a lane where a vehicle is located, and assigning the reliability value to the object based on the second axis coordinate of the point corresponding to the object being located in the second axis range.

The method, may further comprise: assigning, to the object, an identifier indicating that the object is moving or movable, based on determining that the object is moving or movable.

The method, wherein the specified speed indicates a threshold value for determining whether the object is moving or movable, based on a minimum first axis coordinate value of the object or a maximum first axis coordinate value of the object being included in the range, and wherein values of the first axis coordinates of points included in the range are included between: a value of a first axis coordinate of a point corresponding to a vehicle and a value of a second axis coordinate separated from the first axis coordinate of the point corresponding to the vehicle by a threshold distance in a direction of the first axis.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram showing an object recognition apparatus according to an example of the present disclosure;

FIG. 2 shows an example of a table showing information required to classify objects in an object recognition apparatus or an object recognition method according to an example of the present disclosure;

FIG. 3 shows an example of an area in which the weights of reliability values vary according to information related to an object recognition apparatus or an object recognition method according to an example of the present disclosure;

FIG. 4 shows an example of an object appearing in a specified area in an object recognition apparatus or an object recognition method according to an example of the present disclosure;

FIG. 5 shows an example of a flowchart of operation of an object recognition apparatus for determining whether an object is a moving object or an object capable of being in a moving state, based on whether the object appears in a specified area in in an object recognition apparatus or an object recognition method according to an example of the present disclosure;

FIG. 6 shows examples of an object appearing in a specified area and an object not appearing in a specified area in an object recognition apparatus or an object recognition method according to an example of the present disclosure;

FIG. 7 shows an example of determination for determining whether an object appears in a specified area in an object recognition apparatus, or an object recognition method according to an example of the present disclosure;

FIG. 8 shows an example of a flowchart of operation of an object recognition apparatus for assigning a first boundary object feature, and a second boundary object feature to an object, in the object recognition apparatus or an object recognition method according to an example of the present disclosure;

FIG. 9 shows an example of determination for determining whether an object, located in a lane spaced apart from a lane in which a host vehicle is located, appears in a specified area in an object recognition apparatus, or an object recognition method according to an example of the present disclosure;

FIG. 10 shows an example of a flowchart of operation of an object recognition apparatus for assigning a reliability value to an object in the object recognition apparatus, or an object recognition method according to an example of the present disclosure; and

FIG. 11 shows an example of a computing system related to an object recognition apparatus and an object recognition method according to an example of the present disclosure.

### DETAILED DESCRIPTION

Hereinafter, some examples of the present disclosure will be described in detail with reference to the exemplary drawings. In adding the reference numerals to the components of each drawing, it should be noted that the identical or equivalent component is designated by the identical numeral even when they are displayed on other drawings. Further, in describing the example of the present disclosure, a detailed description of well-known features or functions will be ruled out in order not to unnecessarily obscure the gist of the present disclosure.

In describing the components of the example according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

Further, the terms “unit”, “device”, “member”, “body”, or the like used hereinafter may indicate at least one shape structure or may indicate a unit for processing a function.

In addition, in examples of the present disclosure, the expressions “greater than” or “less than” may be used to indicate whether a specific condition is satisfied or fulfilled, but are used only to indicate examples, and do not exclude “greater than or equal to” or “less than or equal to”. A condition indicating “greater than or equal to” may be replaced with “greater than”, a condition indicating “less than or equal to” may be replaced with “less than”, a condition indicating “greater than or equal to and less than” may be replaced with “greater than and less than or equal to”. In addition, ‘A’ to ‘B’ means at least one of elements from A (including A) to B (including B).

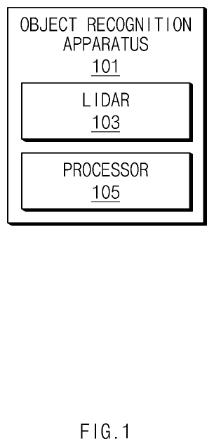

Hereinafter, examples of the present disclosure will be described in detail with reference to FIGS. 1 to 11.

FIG. 1 shows an example of a block diagram showing an object recognition apparatus according to an example of the present disclosure.

Referring to FIG. 1, an object recognition apparatus 101 according to an example of the present disclosure may be implemented inside a vehicle. In this case, the object recognition apparatus 101 may be integrally formed with internal control units of the vehicle, or may be implemented as a separate device and connected to the control units of the vehicle by separate connection means.

Referring to FIG. 1, the object recognition apparatus 101 may include a LIDAR 103 and a processor 105.

According to an example, the processor 105 of the object recognition apparatus 101 may obtain location information of points of an object around a vehicle including the object recognition apparatus 101 through the LIDAR 103. The processor 105 of the object recognition apparatus 101 may acquire a point cloud representing the object through the LIDAR 103. The processor 105 of the object recognition apparatus 101 may determine contour points among points included in the point cloud.

According to an example, the processor 105 of the object recognition apparatus 101 may determine position information of a point corresponding to an object based on contour points representing the object. For example, the point corresponding to the object may include a center point of the most preceding line segment in the moving direction of the object among line segments constituting an object box including contour points representing the object. The center point may be referred to as a tracking point, but may not be limited thereto. For example, the point corresponding to the object may include, but is not limited to, the rightmost point among the contour points included in the object box. For example, the point corresponding to the object may include, but is not limited to, the leftmost point among the contour points included in the object box.

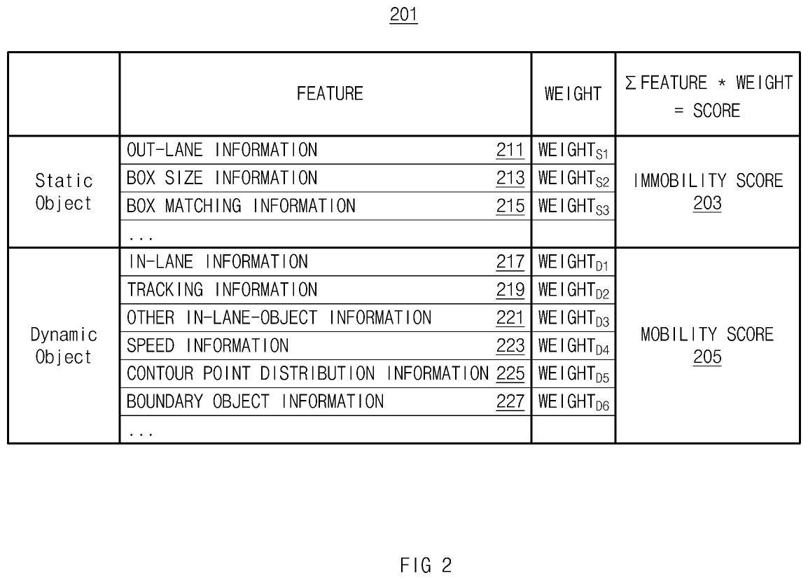

According to an example, the processor 105 of the object recognition apparatus 101 may calculate a score value indicating a probability that an object is a moving object (e.g. a moving vehicle) or an object that is able to be in a moving state (e.g. a stationary vehicle), based on a reliability value according to boundary object information of the object. The determining of a score value indicating a probability that an object is a moving object or an object capable of being in a moving state based on the reliability value according to the boundary object information will be described below with reference to FIG. 2.

According to an example, the processor 105 of the object recognition apparatus 101 may determine that an object is a moving object or an object that is able to be in a moving state, based on the score value indicating the probability that an object is a moving object or an object that is able to be in a moving state being greater than the score value indicating the probability that an object is an object that is unable to be in a moving state.

According to an example, the processor 105 of the object recognition apparatus 101 may assign, to the object, an identifier indicating that the object is a moving object or an object that is able to be in a moving state based on determining that the object is a moving object or an object that is able to be in a moving state. The processor 105 of the object recognition apparatus 101 may assign, to the object, an identifier indicating that the object is an object incapable of being in a moving state, based on determining the object is an object incapable of being in a moving state. The identifier may be referred to as a flag, but may not be limited thereto.

FIG. 2 shows an example of a table showing information required to classify objects in an object recognition apparatus or an object recognition method according to an example of the present disclosure.

Referring to FIG. 2, table 201 may represent types of information for calculating a score for determining whether an object is a moving object (e.g., a vehicle) or a movable object (e.g., an object that is able to be in a moving state). An immobility score 203 may represent a score for determining whether an object is a stationary object (e.g., an object that is unable to be in a moving state, for example, affixed road signs). The immobility score 203 may be identified based on information such as out-lane information 211, box size information 213, and box matching information 215. A mobility score 205 may represent a score for determining whether an object is a moving object or an object that is able to be in a moving state. The mobility score 205 may be identified based on information such as in-lane information 217, tracking information 219, other in-lane-object information 221, speed information 223, contour point distribution information 225, and boundary object information 227.

According to an example, a first reliability may be a reliability value for determining whether an object is an object incapable of being in a moving state. The processor of the object recognition apparatus may determine the immobility score 203 by the sum of values obtained by multiplying first reliabilities indicated by pieces of information by a weight. A second reliability may be a reliability value for determining whether an object is a moving object or an object capable of being in a moving state. The processor of the object recognition apparatus may determine the mobility score 205 by the sum of values obtained by multiplying second reliabilities indicated by pieces of information by a weight.

According to an example, the out-lane information 211 for determining the immobility score 203 may represent a first reliability value assigned based on whether an object is identified outside a lane. The box size information 213 for determining the immobility score 203 may represent a first reliability value assigned based on whether the size of an object box is greater than or equal to a reference size. The box matching information 215 for determining the immobility score 203 may represent a first reliability value assigned based on the distribution of contour points and the degree of matching of the object box.

According to an example, the in-lane information 217 may represent a second reliability value assigned based on whether an object is identified inside a lane. The tracking information 219 may represent a second reliability value assigned based on whether an object is moving. The speed information 223 may represent a second reliability assigned based on the speed of an object. The boundary object information 227 may represent a second reliability value assigned based on whether an object appears without being occluded at the boundary of a field of view.

According to an example, the immobility score 203 may be identified by the sum of values obtained by multiplying the first reliabilities represented by pieces of information by a weight. For example, the immobility score 203 may be identified by the sum of a value obtained by multiplying the first reliability value according to the out-lane information 211 by a weight (e.g., weight_{S1}) corresponding to the out-lane information 211, a value obtained by multiplying the first reliability value according to the box size information 213 by a weight (e.g., weight_{S2}) corresponding to the box size information 213, a value obtained by multiplying the first reliability value according to the box matching information 215 a by weight (e.g., weight_{S3}) corresponding to the box matching information 215, or at least one of any combination thereof. However, examples of the present disclosure may not be limited thereto. According to an example, the immobility score 203 may be identified by adding up not only a value obtained by multiplying information listed in the table 201 by a weight, but also a value obtained by multiplying information not listed in the table 201 by the weight.

According to an example, the mobility score 205 may be identified by the sum of values obtained by multiplying the second reliabilities represented by pieces of information by a weight. For example, the mobility score 205 may be identified by the sum of at least one of a value obtained by multiplying the second reliability value according to the in-lane information 217 by a weight (e.g., weight_{D1}) corresponding to the in-lane information 217, a value obtained by multiplying the second reliability value according to the tracking information 219 by a weight (e.g., weight_{D2}) corresponding to the tracking information 219, a value obtained by multiplying the second reliability value according to the other in-lane-object information 221 by a weight (e.g., weight_{D3}) corresponding to the other in-lane-object information 221, a value obtained by multiplying the second reliability value according to the speed information 223 by a weight (e.g., weight_{D4}) corresponding to the speed information 223, a value obtained by multiplying the second reliability value according to the contour point distribution information 225 by a weight (e.g., weight_{D5}) corresponding to the contour point distribution information 225, a value obtained by multiplying the second reliability value according to the boundary object information 227 by a weight (e.g., weight_{D6}) corresponding to the boundary object information 227, or any combination thereof. However, examples of the present disclosure may not be limited thereto. According to an example, the mobility score 205 may be identified by adding up not only a value obtained by multiplying information listed in the table 201 by a weight, but also a value obtained by multiplying information not listed in the table 201 by the weight.

According to an example, if the mobility score 205 for a certain object is higher than the immobility score 203 for the certain object, the processor of the object recognition apparatus may determine that the certain object is a moving object or an object that is able to be in a moving state. According to an example, if the immobility score 203 for a certain object is higher than the mobility score 205 for the certain object, the processor of the object recognition apparatus may determine that the certain object is an object that is unable to be in a moving state.

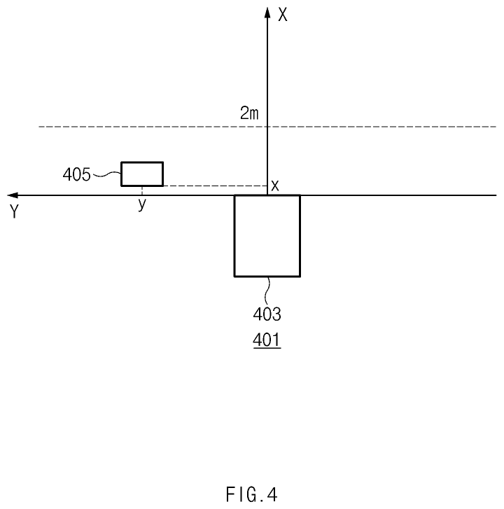

According to an example of the present disclosure, the processor of the object recognition apparatus may determine the second reliability value represented by the boundary object information 227. A method for determining the second reliability value represented by the boundary object information 227 according to an example will be described below with reference to FIGS. 4 to 10. Hereinafter, a value of the second reliability represented by the boundary object information 227 may be referred to as a reliability value.

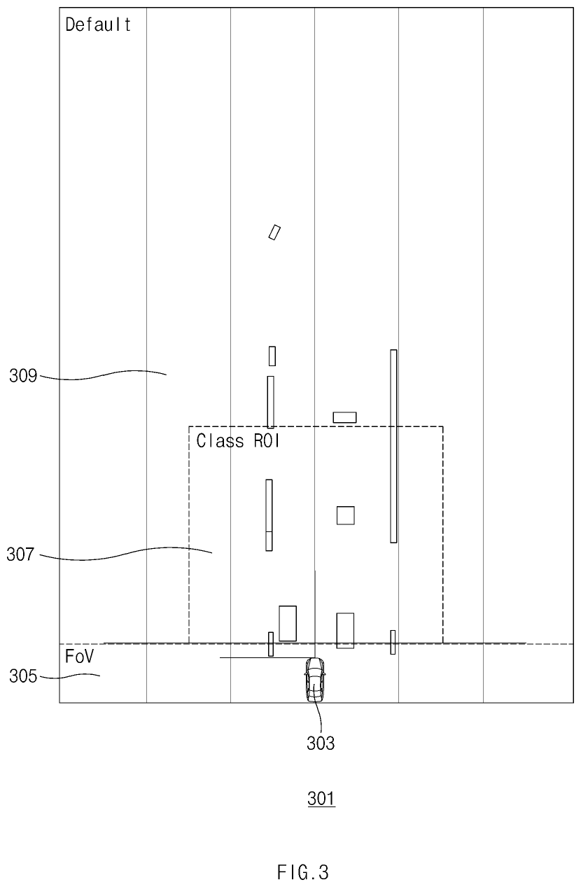

FIG. 3 shows an example of an area in which the weights of reliability values vary according to information related to an object recognition apparatus or an object recognition method according to an example of the present disclosure.

Referring to FIG. 3, a frame 301 may represent a first area 305, a second area 307, and a third area 309 separated according to a distance from a host vehicle 303 including the object recognition apparatus. The first area 305 may include an area within a field of view. The second area 307 may include an area for classifying objects of interest. The third area 309 may include areas other than the first area 305 and the second area 307.

According to an example, the first area 305 may be referred to as a field of view (FoV) area, but may not be limited thereto. The second area 307 may be referred to as a class area of interest (class ROI), but may not be limited thereto. The third area 309 may be referred to as a default area, but may not be limited thereto.

According to an example, the processor of the object recognition apparatus may assign different weights (e.g., weights in FIG. 2) for determining an immobility score or a mobility score according to an area in which an object is included. This is because information of high importance may be changed depending on the position of an object. For example, the processor of the object recognition apparatus may set a weight of contour point distribution information (e.g., the contour point distribution information 225 in FIG. 2) to a value greater than a default value (e.g., 0) only in the second area 307. For example, the processor of the object recognition apparatus may set a weight of boundary object information (e.g., the boundary object information 227 in FIG. 2) in the first area 305 greater than a weight of the boundary object information in the second area 307 and a weight of the boundary object information in the third area 309.

FIG. 4 shows an example of an object appearing in a specified area in an object recognition apparatus or an object recognition method according to an example of the present disclosure.

The processor of the object recognition apparatus may determine contour points that are identified in a plane formed by a first axis and a second axis among the first axis, the second axis, and a third axis in a specific frame and included in an object box representing an object. The first axis may include the x-axis. The second axis may include the y-axis. The third axis may include the z-axis.

Referring to FIG. 4, in situation 401, an object 405 may be located in a specified range identified from the position of a host vehicle 403 including an object recognition apparatus.

According to an example, the object recognition apparatus included in the host vehicle 403 may determine whether an object appears in the specified area. The specified area may be referred to as a field of view (FoV) area, but may not be limited thereto.

According to an example, the object recognition apparatus included in the host vehicle 403 may determine whether a minimum x-axis coordinate that is the smallest value among the x-axis coordinates of contour points included in the object box representing the object falls within a specified range, or a maximum x-axis coordinate that is the largest value among the x-axis coordinates of the contour points falls within a specified range. According to an example, the processor of the object recognition apparatus may determine that the object is included in the specified area if the minimum x-axis coordinate and the maximum x-axis coordinate fall within the specified range.

According to an example, the values of the x-axis coordinates of points included in the specified range (e.g., the range of points with x-axis coordinates greater than or equal to a range of distance, for example, about 0 m and less than about 2 m) may be included between the value of the x-axis coordinate of a point corresponding to the host vehicle 403 and the value of an x-axis coordinate separated from the x-axis coordinate of the point corresponding to the host vehicle 403 by a threshold distance in the x-direction.

According to an example, if the object 405 does not exist or does not appear in a first frame before the specific frame, the processor of the object recognition apparatus may determine that the object 405 appears in the specific frame. The object 405 may appear in the specific frame as the host vehicle 403 has moved (e.g., forward or backward) from one point to another point (e.g., the (−x)-axis direction to the (+x)-axis direction.

According to an example, the processor of the object recognition apparatus may determine whether all or part of the contour points representing the object 405 are not occluded by an object other than the object 405. This is because the processor of the object recognition apparatus must determine whether the object 405 (e.g., guardrail or a road sign) is occluded or obstructed by another object (e.g., truck or a tree) and appears in the specific frame.

According to an example, the processor of the object recognition apparatus may determine whether a moved distance of the object 405 between the specific frame and a second frame after the specific frame is greater than a specified distance, or whether the speed of the object 405 is greater than a specified speed. The specified speed may represent a threshold value (e.g., about 5 kph*a time between the specific frame and the second frame) for determining that the object 405 is moving or movable (e.g., a moving object or an object capable of being in a moving state), based on the minimum x-axis coordinate of the object 405 or the maximum x-axis coordinate of the object 405 being included in the specified range (e.g., a threshold range).

According to an example, the processor of the object recognition apparatus may assign a reliability value to the object 405 based on determining at least one: that at least one of the minimum x-axis coordinate and the maximum x-axis coordinate falls within the specified range, that the object 405 does not exist in the first frame, that all or part of contour points are not occluded by another object, that a moved distance is greater than a specified distance, or that the speed of the object 405 is greater than a specified speed, or any combination thereof.

If the speed of the object 405 is greater than the specified speed, the object 405 appears in the field of view (FoV) area according to the specified range, or the moved distance of the object 405 is greater than the specified distance without the object not being occluded by another object, the object 405 may be determined to pass the host vehicle 403 from one direction to another direction (e.g., the (−x)-axis direction to the (+x)-axis direction). Because it has been identified based on the moved distance of the object 405 or the speed of the object 405 that the object is not an object (e.g., a traffic cone) incapable of being in a moving state or movable, the object 405 may be identified as a moving object or a movable object (e.g., an object capable of being in a moving state). This is because there is a high probability that an object passing the host vehicle 403 from one direction to another direction (e.g., the (−x)-axis direction to the (+x)-axis direction is a moving object or an object capable of being in a moving state.

According to an example, as described with reference to FIG. 2, the reliability value may include a reliability value according to boundary object information (e.g., boundary object information 227 in FIG. 2). The processor of the object recognition apparatus may determine whether the object 405 is a moving object or an object capable of being in a moving state, based on the reliability value.

According to an example, the processor of the object recognition apparatus may assign, to the object 405, an identifier indicating that the object 405 is a moving object or an object capable of being in a moving state, based on determining that the object 405 is a moving object or an object capable of being in a moving state. The identifier may be referred to as a flag, but may not be limited thereto.

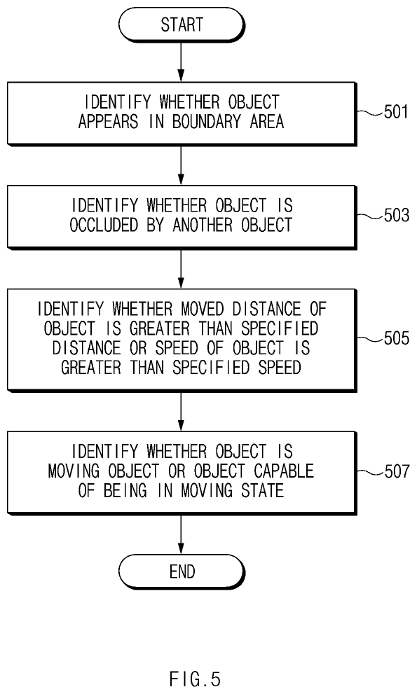

FIG. 5 shows an example of a flowchart of operation of an object recognition apparatus for determining whether an object is a moving object or an object capable of being in a moving state, based on whether the object appears in a specified area in an object recognition apparatus or an object recognition method according to an example of the present disclosure.

Hereinafter, it is assumed that the object recognition apparatus 101 of FIG. 1 performs the process of FIG. 5. Additionally or alternatively, in the description of FIG. 5, operations described as being performed by the apparatus may be understood as being controlled by the processor 105 of the object recognition apparatus 101.

The processor of the object recognition apparatus may determine contour points that are identified in a plane formed by a first axis and a second axis among the first axis, the second axis and a third axis in a specific frame and included in an object box representing an object. The first axis may include the x-axis. The second axis may include the y-axis. The third axis may include the z-axis.

Referring to FIG. 5, in a first operation 501, the processor of the object recognition apparatus according to an example may determine whether an object appears in a boundary area. The boundary area may be referred to as a field of view (FoV) area, but examples of the present disclosure may not be limited thereto.

According to an example, the processor of the object recognition apparatus may determine whether an object is located in a boundary area based on a minimum x-axis coordinate that is the smallest value among the x-axis coordinates of contour points included in the object box representing the object falling within a specified range, or a maximum x-axis coordinate that is the largest value among the x-axis coordinates of the contour points falling within a specified range.

According to another example, the processor of the object recognition apparatus may determine whether the minimum x-axis coordinate falls within the specified range and then determine whether the maximum x-axis coordinate falls within the specified range based on determining that the minimum x-axis coordinate falls within the specified range. The processor of the object recognition apparatus may determine that the object is located in the boundary area based on the minimum x-axis coordinate or the maximum x-axis coordinate being included in the specified range.

The processor of the object recognition apparatus may determine whether an object appears in the boundary area based on determining that the object is located in the boundary area and that the object does not exist in the first frame before the specific frame.

In a second operation 503, the processor of the object recognition apparatus according to an example may determine whether the object is occluded by another object. This is because, if an object is occluded by another object, there is a high probability that the object was not identified in the first frame because the object is present in the first frame before the specific frame, but is occluded by another object. Further, this is because, if an object is occluded by another object, a part of the object that is not unobstructed may be identified as appearing in the boundary area as the part of the object that is not unobstructed by the another object changes.

In a third operation 505, the processor of the object recognition apparatus according to an example may determine whether the moved distance of the object is greater than a specified distance or whether the speed of the object is greater than a specified speed.

The processor of the object recognition apparatus may determine a moved distance of the object between a specific frame and a second frame after the specific frame. This is because, if the moved distance of the object is greater than a specified distance (e.g., approximately 5 kph*time between the specific frame and the second frame), the processor of the object recognition apparatus determine that the speed of the object is greater than a specified speed (e.g., approximately 5 kph). The processor of the object recognition apparatus may determine the speed of the object based on the moved distance of the object, but an operation of determining the speed of the object may not be limited thereto. For example, the processor of the object recognition apparatus may determine the speed of an object through a sensor.

The processor of the object recognition apparatus may assign, to the object, a reliability value included in the boundary object information based on determining at least one of: that the object is located in the boundary area, that the object is not present in the first frame, that the object is not occluded by another object, that the moved distance of the object is greater than the specified distance, or that the speed of the object is greater than a specified speed, or any combination thereof.

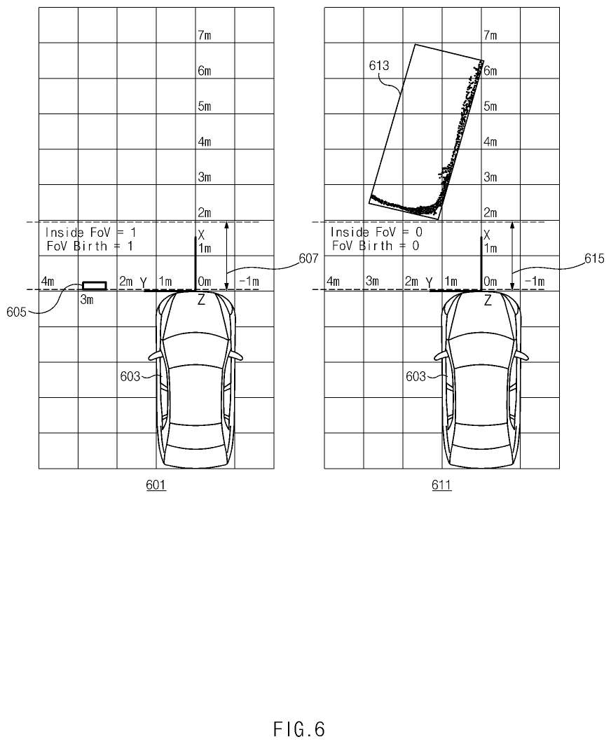

It should be noted that the processor of the object recognition apparatus may assign a reliability value to an object in a specific frame even if an object that satisfies a specific condition exists in the first f frame. Whether the specific condition is satisfied may be identified by a first boundary object feature and a second boundary object feature, which will be described below with reference to FIGS. 6 to 9.

In a fourth operation 507, the processor of the object recognition apparatus according to an example may determine whether the object is a moving object or an object capable of being in a moving state.

The processor of the object recognition apparatus may determine the reliability value assigned to the object to determine whether the object is a moving object or an object capable of being in a moving state.

If the mobility score of the object identified based on the reliability value according to the boundary object information (e.g., the mobility score 205 in FIG. 2) is greater than the immobility score of the object (e.g., the immobility score 203 in FIG. 2), the processor of the object recognition apparatus may determine that the object is a moving object or an object capable of being in a moving state.

FIG. 6 shows examples of an object appearing in a specified area and an object not appearing in a specified area in an object recognition apparatus or an object recognition method according to an example of the present disclosure.

The processor of the object recognition apparatus may determine contour points that are identified in a plane formed by a first axis and a second axis among the first axis, the second axis and a third axis in a specific frame and included in an object box representing an object. The first axis may include the x-axis. The second axis may include the y-axis. The third axis may include the z-axis.

Referring to FIG. 6, in a first situation 601, an object recognition apparatus included in a host vehicle 603 may determine that a first object 605 appears in a first boundary area 607. In a second situation 611, the object recognition apparatus included in the host vehicle 603 may determine that a second object 613 does not appear in a second boundary area 615.

According to an example, a processor of the object recognition apparatus may assign, to an object, a first boundary object feature value with a specified value (e.g., about 1) based on a minimum x-axis coordinate that is the smallest value among contour points included in an object box representing the object (e.g., the first object 605, or the second object 613) falling within a specified range (e.g., a range of x-axis coordinates in the first boundary area 607 or a range of x-axis coordinates in the second boundary area 615). The first boundary object feature may be referred to as an inside field of view (inside FoV) variable, but examples of the present disclosure may not be limited thereto.

The processor of the object recognition apparatus may assign a first boundary object feature value that is a different value (e.g., about 0) to the object based on the minimum x-axis coordinate not falling within the specified range. The processor of the object recognition apparatus may assign a first boundary object feature value that is a specified value (e.g., about 1) to the object based on the minimum x-axis coordinate falling within the specified range.

According to an example, the processor of the object recognition apparatus may assign, to an object, a second boundary object feature value that is a specified value (e.g., about 1) based on the object not existing in a first frame before a specific frame and the maximum x-axis coordinate falling within the specified range. The second boundary object feature may be referred to as a field of view birth (FoV birth) variable, but examples of the present disclosure may not be limited thereto.

The processor of the object recognition apparatus may assign the second boundary object feature that is a different value (e.g., about 0) to the object based on the object existing in the first frame or the maximum x-axis coordinate not falling within the specified range.

The processor of the object recognition apparatus may assign, to the object, a second boundary object feature value (e.g., about 0 or 1) which has been assigned to the object in the first frame, based on the assigned first boundary object feature value being the specified value, the object existing in the first frame, or the maximum x-axis coordinate not being included in the specified range.

In the first situation 601, according to an example, the object recognition apparatus may determine that the first object 605 appears in the first boundary area 607, which is a specified area.

The processor of the object recognition apparatus may determine that the minimum x-axis coordinate value of the first object 605 falls within the specified range (e.g., a range of points whose x-axis coordinates are greater than or equal to about 0 m and less than about 2 m). Accordingly, the processor of the object recognition apparatus may assign a first boundary object feature value that is a specified value (e.g., about 1) to the first object 605. The first boundary area 607 may represent the specified range.

The processor of the object recognition apparatus may determine that the object 605 does not exist in a first frame before a specific frame and that the maximum x-axis coordinate of the first object 605 falls within the specified range. Accordingly, the processor of the object recognition apparatus may assign a specified value (e.g., about 1) as the second boundary object feature value of the first object 605.

In the second situation 611, according to an example, the object recognition apparatus of the host vehicle 603 may determine that the second object 613 does not appear in the second boundary area 615. The processor of the object recognition apparatus may determine that the minimum x-axis coordinate value of the second object 613 is not included in the specified range (e.g., a range of points whose x-axis coordinates are greater than or equal to about 0 m and less than about 2 m). Accordingly, the processor of the object recognition apparatus may assign a first boundary object feature value that is a different value from the specified value (e.g., about 0) to the second object 613. The second boundary area 615 may represent the specified range.

The processor of the object recognition apparatus may determine that the object 605 exists in the first frame before the specific frame or that the maximum x-axis coordinate is not included in the specified range. Accordingly, the processor of the object recognition apparatus may assign a different value from the specified value (e.g., about 0) as the second boundary object feature value of the second object 613.

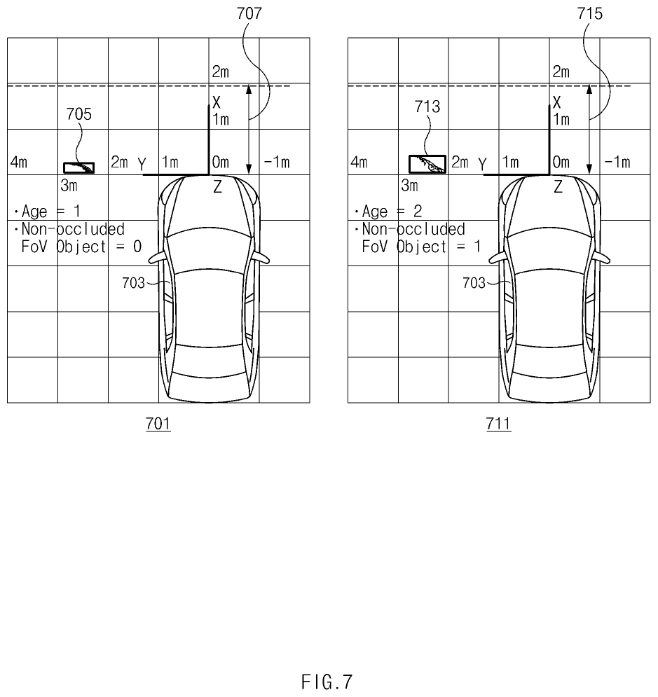

FIG. 7 shows an example of determination for determining whether an object appears in a specified area in an object recognition apparatus, or an object recognition method according to an example of the present disclosure.

The processor of the object recognition apparatus may determine contour points that are identified in a plane formed by a first axis and a second axis among the first axis, the second axis, and a third axis in a specific frame and included in an object box representing an object. The first axis may include the x-axis. The second axis may include the y-axis. The third axis may include the z-axis.

Referring to FIG. 7, in a first frame 701, an object recognition apparatus included in a host vehicle 703 may determine that a first object 705 appears in a first boundary area 707, and that it is hard to determine a moved distance of the first object 705. In a second frame 711, the object recognition apparatus included in the host vehicle 703 may determine that a second object 713 appears in a second boundary area 715 and the moved distance of the second object 713. The first frame 701 may precede the second frame 711.

According to an example, in the first frame 701, the processor of the object recognition apparatus may determine that the first object 705 does not exist in the previous frame of the first frame 701. Accordingly, the age value of the first object 705 may be 1. The age value of the first object 705 may refer to the number of times an object has been continuously identified in previous frames, including a frame immediately preceding the first frame 701.

The processor of the object recognition apparatus may determine that at least one of the minimum x-axis coordinate or the maximum x-axis coordinate of the first object 705 falls within a specified range (e.g., a range of points with x-axis coordinates greater than or equal to about 0 m and less than about 2 m), that the first object 705 does not exist in previous frames of the first frame 701, and that all or part of contour points of the first object 705 are not occluded by another object. The specified area may refer to the first boundary area 707.

It should be noted that the processor of the object recognition apparatus is unable to determine whether the moved distance of the first object 705 is greater than a specified distance because the first object 705 does not exist in the previous frames. Therefore, the processor of the object recognition apparatus may be unable to assign a reliability value according to the boundary object information to the first object 705. The boundary object information may be referred to as a non-occluded FoV object, but examples of the present disclosure may not be limited thereto.

According to an example, in the second frame 711, the processor of the object recognition apparatus may determine the first object 705 identical to the second object 713 in the first frame 701, which is the previous frame of the second frame 711. Accordingly, the age value of the second object 713 may be 2. The age value of the second object 713 may refer to the number of times an object has been continuously identified in previous frames, including a frame immediately preceding the first frame 701.

The processor of the object recognition apparatus may determine a moved distance of the second object 713 between the first frame 701 and the second frame 711 based on the sum of a moved distance of the host vehicle 703 between the first frame 701 and the second frame 711 and a relative moved distance of the second object 713 with respect to the host vehicle 703.

The processor of the object recognition apparatus may determine the relative moved distance of the second object 713 with respect to the host vehicle 703, based on a difference between the position of the representative point of the first object 705 in the first frame 701 and the position of the representative point of the second object 713 in the second frame.

The point of an object corresponding to the representative point of the first object 705 may match the point of an object corresponding to the representative point of the second object 713. The representative point of the object may include points contained in the most preceding line segment in a moving direction of the object, among line segments constituting an object box.

The processor of the object recognition apparatus may determine that at least one of the minimum x-axis coordinate or the maximum x-axis coordinate of the second object 713 falls within a specified range (e.g., a range of points with x-axis coordinates greater than or equal to about 0 m and less than about 2 m), that all or part of contour points of the second object 713 are not occluded by another object, and that a moved distance of the second object 713 between the first frame 701 and the second frame 711 is greater than a specified distance.

It should be noted that the processor of the object recognition apparatus is able to determine the first object 705 that matches the second object 713 in the first frame 701 before the second frame 711. In the first frame 701, the processor of the object recognition apparatus may not be able to determine the moved distance of the first object 705 and thus may not assign a reliability value, but the processor of the object recognition apparatus may assign a specified value (e.g., about 1) as a first boundary object feature value and a second boundary object feature value of the first object 705.

According to an example, the first boundary object feature value of the second object 713 may be identified as being the specified value (e.g., an integer or a real number, about 1). The second boundary object feature value of the second object 713 may be identified as being a value equal (e.g., the specified value 1) to the second boundary object feature value of the first object 705. Accordingly, the processor of the object recognition apparatus may determine the specified value (e.g., an integer or a real number, about 1) as the second boundary object feature value of the first object 705 and the second boundary object feature value of the second object 713 included in the second specific frame 711.

Thus, in the second frame 711, the processor of the object recognition apparatus may assign a reliability value according to the boundary object information to the second object 713 included in the second specific frame 711, based on determining at least one of: that a first boundary object feature value assigned to the second object 713, and a second boundary object feature value assigned to the second object 713 being a specified value (e.g., about 1); that all or part of contour points being unobstructed by another object; a moved distance being greater than a specified distance (e.g., a threshold distance); or a speed of the second object 713 being greater than a specified speed (e.g., a threshold speed); or any combination thereof.

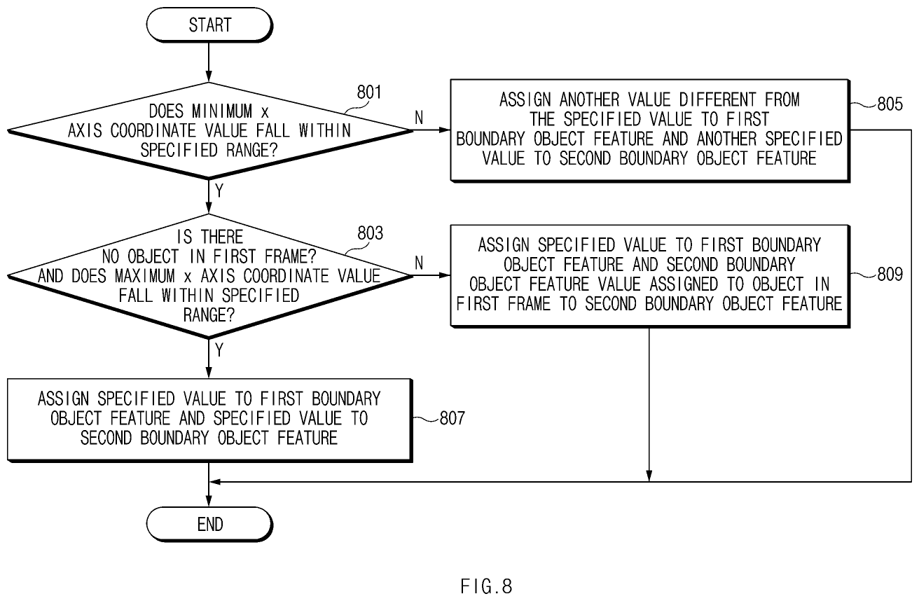

FIG. 8 shows an example of a flowchart of operation of an object recognition apparatus for assigning a first boundary object feature, and a second boundary object feature to an object, in the object recognition apparatus or an object recognition method according to an example of the present disclosure.

Hereinafter, it is assumed that the object recognition apparatus 101 of FIG. 1 performs the process of FIG. 8. Additionally or alternatively, in the description of FIG. 8, operations described as being performed by the apparatus may be understood as being controlled by the processor 105 of the object recognition apparatus 101.

The processor of the object recognition apparatus may determine contour points that are identified in a plane formed by a first axis and a second axis among the first axis, the second axis, and a third axis in a specific frame and included in an object box representing an object. The first axis may include the x-axis. The second axis may include the y-axis. The third axis may include the z-axis.

Referring to FIG. 8, in a first operation 801, the processor of an object recognition apparatus according to an example may determine whether the minimum x-axis coordinate value is within a specified range. If the minimum x-axis coordinate value is within the specified range, the processor of the object recognition apparatus may perform a second operation 803. If the minimum x-axis coordinate value is outside the specified range, the processor of the object recognition apparatus may perform a third operation 805. The specified range may include a range greater than or equal to about 0 m and less than or equal to about 2 m.

In a third operation 805, the processor of the object recognition apparatus according to an example may assign a value of 0 to a first boundary object feature and another specified value to a second boundary object feature. The another specified value may include about zero.

Because the minimum coordinate value is not included in the specified range, the processor of the object recognition apparatus may assign a value (e.g., about 0) different from the value specified for the first boundary object feature of an object. Because an object does exist in a first frame, which is a previous frame of a specific frame, and/or the maximum x-axis coordinate value is not included within about 2 m, the processor of the object recognition apparatus may assign a value (e.g., about 0) different from a value specified for the second boundary object feature of the object.

In a second operation 803, the processor of the object recognition apparatus according to an example may determine whether the object does not exist in the first frame and the maximum x-axis coordinate value is within a specified range. If the object does not exist in the first frame and the maximum x-axis coordinate value is within the specified range, the processor of the object recognition apparatus may perform a fourth operation 807. If the object exists in the first frame, or the maximum x-axis coordinate value is outside the specified range, the processor of the object recognition apparatus may perform a fifth operation 809.

If the minimum x-axis coordinate value is within the specified range, the processor of the object recognition apparatus may assign a specified value (e.g., about 1) to the first boundary object feature of the object.

In the fifth operation 809, the processor of the object recognition apparatus according to an example may assign a specified value to the first boundary object feature, and a second object feature value assigned to the object in the first frame to the second boundary object feature.

The processor of the object recognition apparatus may again determine whether to assign the specified value (e.g., about 1) to the second object feature even though the object exists in the first frame or the maximum x-axis coordinate value is outside the specified range.

If the second boundary object feature of the object in the first frame is a different value (e.g., about 0) from the specified value, the processor of the object recognition apparatus may assign a different value (e.g., about 0) to the second boundary object feature of the object in the specific frame. If the second boundary object feature of the object in the first frame is the specified value (e.g., about 0), the processor of the object recognition apparatus may assign the specified value (e.g., about 1) to the second boundary object feature of the object in the specific frame.

In the fourth operation 807, the processor of the object recognition apparatus according to an example may assign a specified value to the first boundary object feature and a specified value to the second boundary object feature.

The processor of the object recognition apparatus may assign a reliability value to an object included in a specific frame, based on determining at least one of: that a first boundary object feature value assigned to an object in a specific frame and a second boundary object feature value assigned to the object in the specific frame being a specified value; that all or part of contour points not being occluded by another object; a moved distance being greater than a specified distance; or a speed of the object being greater than a specified speed; or any combination thereof.

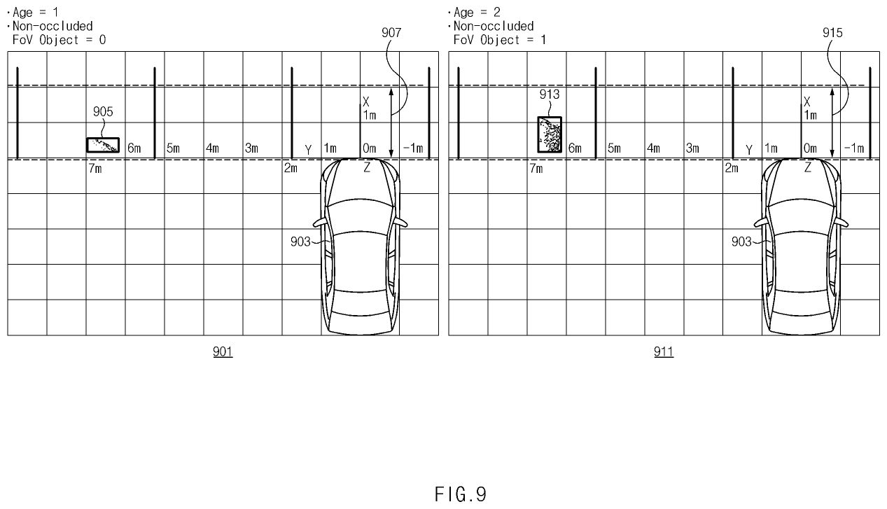

FIG. 9 shows an example of determination for determining whether an object, located in a lane spaced apart from a lane in which a host vehicle is located, appears in a specified area in an object recognition apparatus, or an object recognition method according to an example of the present disclosure.

The processor of the object recognition apparatus may determine contour points that are identified in a plane formed by a first axis and a second axis among the first axis, the second axis, and a third axis in a specific frame and included in an object box representing an object. The first axis may include the x-axis. The second axis may include the y-axis. The third axis may include the z-axis.

Referring to FIG. 9, in a first frame 901, an object recognition apparatus included in a host vehicle 903 may determine a first object 905 appears in a first boundary area 907, and that it is hard to determine a moved distance of the first object 905. In a second frame 911, the object recognition apparatus included in the host vehicle 903 may determine that a second object 913 appears in a second boundary area 915 and the moved distance of the second object 913.

According to an example, a processor of the object recognition apparatus may determine that a y-axis coordinate (e.g., a horizonal coordinate) of a point corresponding to an object (e.g., the first object 905 included in the first frame 901, or the second object 913 included in the second frame 911) falls within a specified y-axis range (e.g., a horizonal range). The specified y-axis range may include a specified number of lanes on both sides of a lane in which the host vehicle 903 is located. The processor of the object recognition apparatus may assign a reliability value to the object based on the y-axis coordinate of a point corresponding to the object being located in the y-axis range. In other words, the processor of the object recognition apparatus may assign a reliability value to the object based on determining at least one of: that the y-axis coordinate falls within the specified y-axis range, that at least one of the minimum x-axis coordinate (e.g., a smallest value of a vertical coordinate) of the object and the maximum x-axis coordinate (e.g., a largest value of the vertical coordinate) of the object falls within the specified range, that the object is absent in a previous frame, that all or part of contour points are unobstructed or not occluded by another object, that a moved distance of the object is greater than a specified distance (e.g., a threshold distance), or that the speed of the object is greater than a specified speed (e.g., a threshold speed), or any combination thereof.

According to an example, the processor of the object recognition apparatus may determine that the y-axis coordinate of a point corresponding to the first object 905 falls within a specified y-axis range. The specified y-axis range may include a specified number of lanes (e.g., about one, two, or more) on both sides of a lane in which the host vehicle 903 is located.

The processor of the object recognition apparatus may determine that the y-axis coordinate of the point corresponding to the first object 905 falls within the specified y-axis range, at least one of the minimum x-axis coordinate or the maximum x-axis coordinate of the first object 905 falls within a specified range (e.g., a range of points with x-axis coordinates greater than or equal to about 0 m and less than about 2 m), that the first object 905 is absent in previous frames (e.g., another frame prior to the first frame 901) of the first frame 901, and that all or part of contour points of the first object 905 are not occluded or unobstructed by another object. The specified area may refer to the first boundary area 907.

It should be noted that the processor of the object recognition apparatus is unable to determine whether the moved distance of the first object 905 is greater than a specified distance (e.g., a threshold distance) because the first object 905 is absent or non-existing in the previous frames (e.g., one or more frames before the first frame 901). Therefore, the processor of the object recognition apparatus may be unable to assign a reliability value according to the boundary object information to the first object 905 in the first frame 901. The boundary object information may be referred to as a non-occluded or unobstructed FoV object, but examples of the present disclosure may not be limited thereto.

According to an example, in the second frame 911, the processor of the object recognition apparatus may determine that the y-axis coordinate (e.g., a horizontal coordinate value) of a point corresponding to the second object 913 falls within the specified y-axis range. The specified y-axis range may include a specified number of lanes (e.g., about one, two, or more) on both sides of a lane in which the host vehicle 903 is located. As the processor of the object recognition apparatus identifies or determines that the first object 905 in the first frame 901 is identical to the second object 913 in the second frame 911, which is a frame after the first frame 901, the processor of the object recognition apparatus may determine an age value of the second object 913 as being older than an age value of the first object 901 (e.g., one), for example, two.

The processor of the object recognition apparatus may determine that the first object 905 in the first frame 901 matches the second object 913 in the second frame 911 that is after the first frame 901. In the first frame 901, the processor of the object recognition apparatus may not be able to determine the moved distance of the first object 905 and thus may not assign a reliability value, but the first object 905 in the first frame 901 may have a specified value (e.g., a common or same value) as a first boundary object feature value and a second boundary object feature value.

Accordingly, the processor of the object recognition apparatus may determine the specified value (e.g., the common value) as the second boundary object feature value of the second object 913 in the second frame 911.

Thus, in the second frame 911, the processor of the object recognition apparatus may assign a reliability value according to the boundary object information to the second object 913 included in the second specific frame 911, based on determining at least one of: that the y-axis coordinate of the point corresponding to the second object 913 falls within the specified y-axis range; that a first boundary object feature value assigned to the second object 913, and a second boundary object feature value assigned to the second object 913 being a specified value, in the second frame 911; that all or part of contour points not being occluded by another object; a moved distance being greater than a specified distance; or a speed of the second object 913 being greater than a specified speed (e.g., a threshold speed); or any combination thereof.

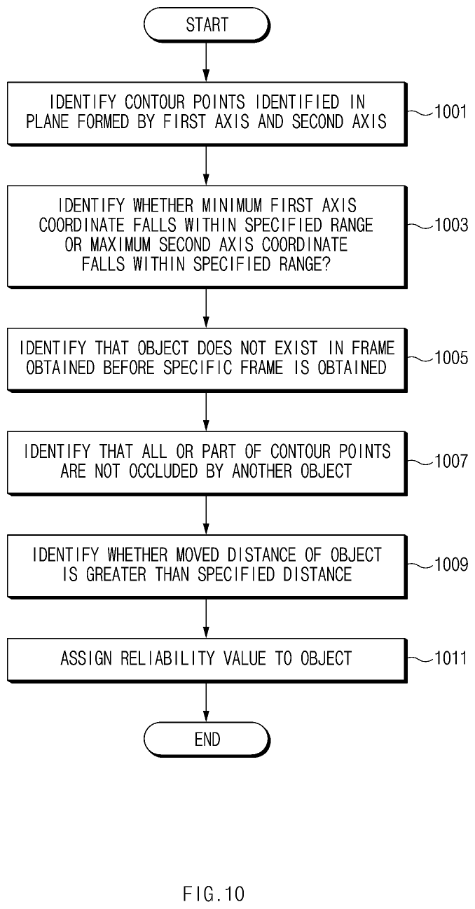

FIG. 10 shows an example of a flowchart of operation of an object recognition apparatus for assigning a reliability value to an object in the object recognition apparatus, or an object recognition method according to an example of the present disclosure.

Hereinafter, it is assumed that the object recognition apparatus 101 of FIG. 1 performs the process of FIG. 10. Additionally or alternatively, in the description of FIG. 10, operations described as being performed by the apparatus may be understood as being controlled by the processor 105 of the object recognition apparatus 101.

Referring to FIG. 10, in a first operation 1001, the processor of an object recognition apparatus according to an example may determine contour points identified in a plane formed by a first axis and a second axis.

The processor of the object recognition apparatus may determine contour points that are identified in a plane formed by the first axis and the second axis among the first axis, the second axis, and a third axis in a specific frame and included in an object box representing an object. The first axis may include the x-axis. The second axis may include the y-axis. The third axis may include the z-axis.

In a second operation 1003, according to an example, the processor of the object recognition apparatus may determine whether the minimum first axis coordinate falls within a specified range, or the maximum first axis coordinate falls within a specified range.

In a third operation 1005, according to an example, the processor of the object recognition apparatus may determine whether an object does not exist in a first frame before a specific frame.

In a fourth operation 1007, according to an example, the processor of the object recognition apparatus may determine whether all or part of contour points are not occluded by another object.

In a fifth operation 1009, according to an example, the processor of the object recognition apparatus may determine whether a moved distance of the object is greater than a specified distance.

In a sixth operation 1011, according to an example, the processor of the object recognition apparatus may assign a reliability value to the object. The processor of the object recognition apparatus may determine that the object is a moving object or an object capable of being in a moving state, based on the reliability value.

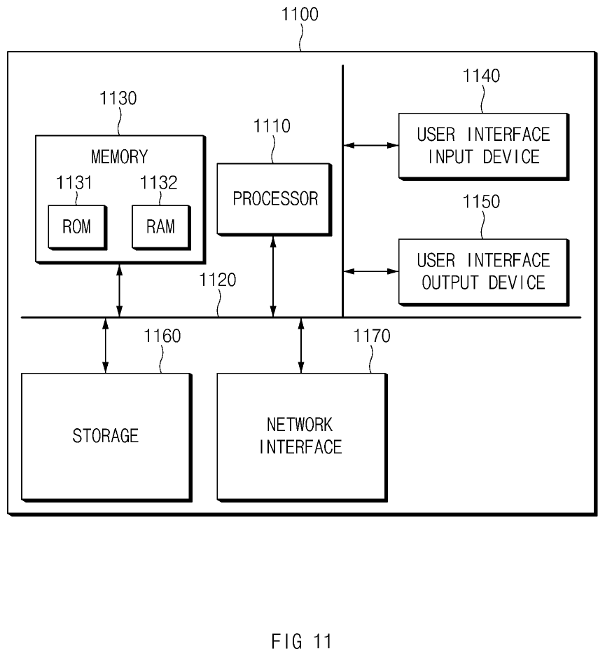

FIG. 11 shows an example of a computing system related to an object recognition apparatus and an object recognition method according to an example of the present disclosure.

Referring to FIG. 11, a computing system 1100 may include at least one processor 1110, a memory 1130, a user interface input device 1140, a user interface output device 1150, storage 1160, and a network interface 1170, which are connected with each other via a bus 1120.

The processor 1110 may be a central processing unit (CPU) or a semiconductor device that processes instructions stored in the memory 1130 and/or the storage 1160. The memory 1130 and the storage 1160 may include various types of volatile or non-volatile storage media. For example, the memory 1130 may include a ROM (Read Only Memory) 1131 and a RAM (Random Access Memory) 1132.

Thus, the operations of the method or the algorithm described in connection with the examples disclosed herein may be embodied directly in hardware or a software module executed by the processor 1110, or in a combination thereof. The software module may reside on a storage medium (that is, the memory 1130 and/or the storage 1160) such as a RAM, a flash memory, a ROM, an EPROM, an EEPROM, a register, a hard disk, a removable disk, and a CD-ROM.

The exemplary storage medium may be coupled to the processor 1110, and the processor 1110 may read information out of the storage medium and may record information in the storage medium. Alternatively, the storage medium may be integrated with the processor 1110. The processor and the storage medium may reside in an application specific integrated circuit (ASIC). The ASIC may reside within a user terminal. In another case, the processor 1100 and the storage medium may reside in the user terminal as separate components.

The present disclosure has been made to solve the above-mentioned problems occurring in the prior art while advantages achieved by the prior art are maintained intact.

An example of the present disclosure provides an object recognition apparatus and method for determining whether an object is a moving object or an object capable of being in a moving state.

Another example of the present disclosure provides an object recognition apparatus and method for determining whether an object appearing in a specified range is a moving object or an object capable of being in a moving state.

Another example of the present disclosure provides an object recognition apparatus and method for improving the accuracy of determination of determining whether an object located in a specified range is a moving object or an object capable of being in a moving state.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, an object recognition apparatus includes a LIDAR, a processor.

According to an example, the processor may determine contour points identified in a plane formed by a first axis, a second axis among the first axis, the second axis, and a third axis in a specific frame and included object box representing an object, determine whether a minimum first axis coordinate, which is a smallest value of first axis coordinates of the contour points, falls within a specified range, or whether a maximum first axis coordinate, which is a largest value of the first axis coordinates of the contour points, falls within the specified range, determine whether the object does not exist in a first frame before the specific frame, determine whether all or part of the contour points are not occluded by another object different from the object, determine whether a moved distance of the object between the specific frame and a second frame after the specific frame is greater than a specified distance, or whether a speed of the object is greater than a specified speed, assign a reliability value to the object based on determining at least one of that the minimum first axis coordinate and the maximum first axis coordinate falls within the specified range, that the object does not exist in the first frame, that all or part of the contour points are not occluded by the another object, that the moved distance is greater than the specified distance, or that the speed of the object is greater than the specified speed, or any combination thereof, and determine that the object is a moving object or an object capable of being in a moving state based on the reliability value.

According to an example, the processor may determine whether the minimum first axis coordinate falls within the specified range, and determine whether the maximum first axis coordinate falls within the specified range based on determining that the minimum first axis coordinate falls within the specified range.

According to an example, the processor may assign a first boundary object feature value that is a specified value to the object based on the minimum first axis coordinate falling within the specified range, assign a second boundary object feature value that is a specified value to the object, based on the object not existing in the first frame and the maximum first axis coordinate falling within the specified range, assign, to the object, the second boundary object feature value assigned to the object in the first frame based on the assigned first boundary object feature value being the specified value, the object existing in the first frame, or the maximum first axis coordinate not falling with the specified range, and assign the reliability value to the object included in the specific frame, based on determining at least one of: that the first boundary object feature value assigned to the object in the specific frame and the second boundary object feature value assigned to the object in the specific frame being the specified value, that all or part of contour points not being occluded by another object, the moved distance being greater than the specified distance; or the speed of the object being greater than a specified speed; or any combination thereof.

According to an example, the processor may identify, a relative moved distance of the object with respect to the host vehicle based on a difference between a position of a point corresponding to the object in the specific frame and a position of a point corresponding to the object in the second frame, determine the moved distance based on a sum of a moved distance of the host vehicle and the relative moved distance of the object, and allow the point corresponding to the object in the specific frame to match the point corresponding to the object in the second frame.

According to an example, the processor may determine a center point contained in a most preceding line segment in a moving direction of the object among line segments constituting the object box as a point corresponding to the object or determine another point contained in the line segment as the point corresponding to the object.

According to an example, the values of first axis coordinates of points included in the specified range may be included between a value of a first axis coordinate of a point corresponding to the host vehicle and a value of a first axis coordinate separated from the first axis coordinate of the point corresponding to the host vehicle by a threshold distance in a direction of the first axis.

According to an example, the processor may determine that a second axis coordinate of a point corresponding to the object falls within a specified second axis range, and assign a reliability value to the object based on determining at least one of that the second axis coordinate falls within the specified second axis range, that the minimum first axis coordinate and the maximum first axis coordinate falls within the specified range, that the object does not exist in the first frame, that all or part of the contour points are not occluded by the another object, that the moved distance is greater than the specified distance, or that the speed of the object is greater than the specified speed, or any combination thereof.

According to an example, the processor may determine whether a second axis coordinate of a point corresponding to the object is located in a second axis range including a specified number of lanes on both sides of a lane where the host vehicle is located, and assign the reliability value to the object based on the second axis coordinate of the point corresponding to the object being located in the second axis range.

According to an example, the processor may assign, to the object, an identifier indicating that the object is a moving object or an object capable of being in a moving state, based on determining that the object is the moving object or the object capable of being in a moving state.

According to an example, the specified speed may indicate a threshold value for determining whether the object is a moving object or an object capable of being in a moving state, based on the minimum first axis coordinate of the object or the maximum first axis coordinate of the object being included in the specified range. The values of first axis coordinates of points included in the specified range may be included between a value of a first axis coordinate of a point corresponding to the host vehicle and a value of a first axis coordinate separated from the first axis coordinate of the point corresponding to the host vehicle by a threshold distance in a direction of the first axis.

According to an example of the present disclosure, an object recognition method includes determining contour points identified in a plane formed by a first axis and a second axis among the first axis, the second axis, and a third axis in a specific frame and included object box representing an object, determining whether a minimum first axis coordinate, which is a smallest value of first axis coordinates of the contour points, falls within a specified range or whether a maximum first axis coordinate, which is a largest value of the first axis coordinates of the contour points, falls within the specified range, determining whether the object does not exist in a first frame before the specific frame, determining whether all or part of the contour points are not occluded by another object different from the object, determining whether a moved distance of the object between the specific frame and a second frame after the specific frame is greater than a specified distance or whether a speed of the object is greater than a specified speed, assigning a reliability value to the object based on determining at least one of that the minimum first axis coordinate and the maximum first axis coordinate falls within the specified range, that the object does not exist in the first frame, that all or part of the contour points are not occluded by the another object, that the moved distance is greater than the specified distance, or that the speed of the object is greater than the specified speed, or any combination thereof, and determining that the object is a moving object or an object capable of being in a moving state based on the reliability value.

According to an example, the determining of whether the minimum first axis coordinate, which is the smallest value of first axis coordinates of the contour points, falls within the specified range or whether the maximum first axis coordinate, which is the largest value of the first axis coordinates of the contour points, falls within the specified range may include determining whether the minimum first axis coordinate falls within the specified range, and determining whether the maximum first axis coordinate falls within the specified range based on determining that the minimum first axis coordinate falls within the specified range.

According to an example, the object recognition method may further include assigning a first boundary object feature value that is a specified value to the object based on the minimum first axis coordinate falling g within the specified range, assigning a second boundary object feature value that is a specified value to the object, based on the object not existing in the first frame or the maximum first axis coordinate falling within the specified range, assigning, to the object, the second boundary object feature value assigned to the object in the first frame based on the assigned first boundary object feature value being the specified value, the object existing in the first frame, and the maximum first axis coordinate not falling with the specified range, and assigning the reliability value to the object included in the specific frame, based on determining at least one of: that the first boundary object feature value assigned to the object in the specific frame and the second boundary object feature value assigned to the object in the specific frame being the specified value, that all or part of contour points not being occluded by another object, the moved distance being greater than the specified distance; or the speed of the object being greater than a specified speed; or any combination thereof.

According to an example, the determining of whether the moved distance of the object between the specific frame and the second frame after the specific frame is greater than the specified distance or whether the speed of the object is greater than the specified speed may include determining a relative moved distance of the object with respect to a host vehicle based on a difference between a position of a point corresponding to the object in the specific frame and a position of a point corresponding to the object in the second frame, determining the moved distance based on a sum of a moved distance of the host vehicle and the relative moved distance of the object, and allowing the point corresponding to the object in the specific frame to match the point corresponding to the object in the second frame.

According to an example, the determining of whether the moved distance of the object between the specific frame and the second frame after the specific frame is greater than the specified distance or whether the speed of the object is greater than the specified speed may include determining a center point contained in a most preceding line segment in a moving direction of the object among line segments constituting the object box as a point corresponding to the object or determining another point contained in the line segment as the point corresponding to the object.

According to an example, values of first axis coordinates of points included in the specified range may be included between a value of a first axis coordinate of a point corresponding to a host vehicle and a value of a first axis coordinate separated from the first axis coordinate of the point corresponding to the host vehicle by a threshold distance in a direction of the first axis.

According to an example, the object recognition method may further include determining that a second axis coordinate of a point corresponding to the object falls within a specified second axis range, and assigning a reliability value to the object based on determining at least one of: that the second axis coordinate falls within the specified second axis range, that at least one of the minimum first axis coordinate and the maximum first axis coordinate falls within the specified range, that the object does not exist in the first frame, that all or part of the contour points are not occluded by the another object, that the moved distance is greater than the specified distance, or that the speed of the object is greater than the specified speed; or any combination thereof.

According to an example, the object recognition method may further include determining whether a second axis coordinate of a point corresponding to the object is located in a second axis range including a specified number of lanes on both sides of a lane where a host vehicle is located, and assigning the reliability value to the object based on the second axis coordinate of the point corresponding to the object being located in the second axis range.

According to an example, the object recognition method may further include assigning, to the object, an identifier indicating that the object is a moving object or an object capable of being in a moving state, based on determining that the object is the moving object or the object capable of being in a moving state.

According to an example, the specified speed may indicate a threshold value for determining whether the object is a moving object or an object capable of being in a moving state, based on the minimum first axis coordinate of the object or the maximum first axis coordinate of the object being included in the specified range. The values of first axis coordinates of points included in the specified range may be included between a value of a first axis coordinate of a point corresponding to a host vehicle and a value of a first axis coordinate separated from the first axis coordinate of the point corresponding to the host vehicle by a threshold distance in a direction of the first axis.

The above description is merely illustrative of the technical idea of the present disclosure, and various modifications and variations may be made without departing from the essential characteristics of the present disclosure by those skilled in the art to which the present disclosure pertains.

Accordingly, the example disclosed in the present disclosure is not intended to limit the technical idea of the present disclosure but to describe the present disclosure, and the scope of the technical idea of the present disclosure is not limited by the example. The scope of protection of the present disclosure should be interpreted by the following claims, and all technical ideas within the scope equivalent thereto should be construed as being included in the scope of the present disclosure.

The present technology may increase the accuracy of determination of determining whether an object is a moving object or an object capable of being in a moving state by determining whether an object appears in a specified range.

The present technology may determine whether an object of which a partial shape is identified is a moving object or an object capable of being in a moving state by determining whether an object appears in a specified range.

Further, the present technology may enhance user experience by improving the accuracy of determination of determining whether an object is a moving object or an object capable of being in a moving state.

Further, the present technology may improve the performance of autonomous driving or driver assistance device driving by improving the accuracy of determination of determining whether an object is a moving object or an object capable of being in a moving state.

In addition, various effects may be provided that are directly or indirectly understood through the disclosure.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus comprising:
a sensor; and
a processor,
wherein the processor is configured to:
determine contour points identified in a plane in a specific frame and included in an object box representing an object, wherein the plane is formed by a first axis and a second axis, the first axis corresponding to a moving direction of the sensor, and the second axis being perpendicular to the first axis;
determine whether a minimum value of first axis coordinates of the contour points is within a range, or whether a maximum value of the first axis coordinates of the contour points is within the range;
determine whether the object is absent in a first frame before the specific frame;
determine whether all or part of the contour points are unobstructed by another object different from the object;
determine whether a moved distance of the object between the specific frame and a second frame after the specific frame is greater than a specified distance, or whether a speed of the object is greater than a specified speed;
assign a reliability value to the object based on at least one of:
the minimum value of the first axis coordinates and the maximum value of the first axis coordinates being within the range,
the object being absent in the first frame,
all or part of the contour points being unobstructed by the another object,
the moved distance being greater than the specified distance, or
the speed being greater than the specified speed; and
determine, based on the reliability value, that the object is moving or movable; and
output a signal indicating that the object is moving or movable.

2. The apparatus of claim 1, wherein the processor is configured to:
determine whether the minimum value of the first axis coordinates is within the range; and
determine whether the maximum value of the first axis coordinates is within the range based on a determination that the minimum value of the first axis coordinates is within the range.

3. The apparatus of claim 1, wherein the processor is configured to:
assign, to the object, a first boundary object feature value that is a specified value to the object in the specific frame, based on the minimum value of the first axis coordinates being within the range;
assign, to the object, a second boundary object feature value that is the specified value to the object in the second frame, based on the object being absent in the first frame and the maximum value of the first axis coordinates being within the range;
assign, to the object, the second boundary object feature value assigned to the object in the first frame based on:
the assigned first boundary object feature value being the specified value,
the object existing in the first frame, or
the maximum value of the first axis coordinates not falling within the range; and
assign the reliability value to the object included in the specific frame, based on at least one of:
the first boundary object feature value assigned to the object in the specific frame and the second boundary object feature value assigned to the object in the specific frame being the specified value,
all or part of contour points being unobstructed by another object,
the moved distance being greater than the specified distance; or
the speed of the object being greater than a specified speed.

4. The apparatus of claim 1, wherein the processor is configured to:
determine a relative moved distance of the object with respect to a vehicle based on a difference between a position of a point corresponding to the object in the specific frame and a position of a point corresponding to the object in the second frame;
determine the moved distance based on a sum of a moved distance of the vehicle and the relative moved distance of the object; and
match the point corresponding to the object in the specific frame to the point corresponding to the object in the second frame.

5. The apparatus of claim 4, wherein the processor is configured to:
determine a center point contained in a most preceding line segment in a moving direction of the object among line segments constituting the object box as a point corresponding to the object, or
determine another point contained in the most preceding line segment as the point corresponding to the object.

6. The apparatus of claim 1, wherein values, of the first axis coordinates of points included in the range, are included between:
a value of a first axis coordinate of a point corresponding to a vehicle and a value of a first axis coordinate separated from the first axis coordinate of the point corresponding to the vehicle by a threshold distance in a direction of the first axis.

7. The apparatus of claim 1, wherein the processor is configured to:
determine that a second axis coordinate of a point corresponding to the object is within a second axis range; and
assign the reliability value to the object based on at least one of:
the second axis coordinate being within the second axis range,
at least one of the minimum value of the first axis coordinates and the maximum value of the first axis coordinates being within the range,
the object being absent in the first frame,
all or part of the contour points being unobstructed by the another object,
the moved distance being greater than the specified distance, or
the speed of the object being greater than the specified speed.

8. The apparatus of claim 1, wherein the processor is configured to:
determine whether a second axis coordinate of a point corresponding to the object is located in a second axis range including a specified number of lanes on both sides of a lane where a vehicle is located; and
assign the reliability value to the object based on the second axis coordinate of the point corresponding to the object being located in the second axis range.

9. The apparatus of claim 1, wherein the processor is configured to assign, to the object, an identifier indicating that the object is moving or movable, based on determining that the object is moving or movable.

10. The apparatus of claim 1, wherein the specified speed indicates a threshold value for determining whether the object is moving or movable, based on a minimum first axis coordinate value of the object or a maximum first axis coordinate value of the object being included in the range, and
wherein values of the first axis coordinates of points included in the range are included between:
a value of a first axis coordinate of a point corresponding to a vehicle and
a value of a second axis coordinate separated from the first axis coordinate of the point corresponding to the vehicle by a threshold distance in a direction of the first axis.

11. A method performed by a processor, the method comprising:
determining contour points identified in a plane in a specific frame and included object box representing an object, wherein the plane is formed by a first axis and a second axis, the first axis corresponding to a moving direction of a sensor, and the second axis being perpendicular to the first axis;
determining whether a minimum value of first axis coordinates of the contour points is within a range or whether a maximum value of the first axis coordinates of the contour points is within the range;
determining whether the object is absent in a first frame before the specific frame;
determining whether all or part of the contour points are unobstructed by another object different from the object;
determining whether a moved distance of the object between the specific frame and a second frame after the specific frame is greater than a specified distance or whether a speed of the object is greater than a specified speed;
assigning a reliability value to the object based on at least one of:
that the minimum value of the first axis coordinates and the maximum value of the first axis coordinates being within the range,
the object being absent in the first frame,
all or part of the contour points being unobstructed by the another object,
the moved distance being greater than the specified distance, or
the speed being greater than the specified speed;
determining, based on the reliability value, that the object is moving or movable; and
outputting a signal indicating that the object is moving or movable.

12. The method of claim 11, wherein the determining whether the minimum value is within the range or whether the maximum value is within the range includes:
determining whether the minimum value of the first axis coordinates is within the range; and
determining whether the maximum value of the first axis coordinates is within the range based on determining that the minimum value of the first axis coordinates is within the range.

13. The method of claim 11, further comprising:
assigning, to the object, a first boundary object feature value that is a specified value to the object in the specific frame, based on the minimum value of the first axis coordinates being within the range;
assigning, to the object, a second boundary object feature value that is a specified value to the object in the second frame, based on the object being absent in the first frame and the maximum value of the first axis coordinates being within the range;
assigning, to the object, the second boundary object feature value assigned to the object in the first frame based on:
the assigned first boundary object feature value being the specified value,
the object existing in the first frame, or
the maximum value of the first axis coordinates not falling with the range; and
assigning the reliability value to the object included in the specific frame, based on at least one of:
the first boundary object feature value assigned to the object in the specific frame and the second boundary object feature value assigned to the object in the specific frame being the specified value,
all or part of contour points being unobstructed by another object,
the moved distance being greater than the specified distance; or
the speed of the object being greater than a specified speed.

14. The method of claim 11, wherein the determining whether the moved distance of the object between the specific frame and the second frame after the specific frame is greater than the specified distance or whether the speed of the object is greater than the specified speed includes:
determining a relative moved distance of the object with respect to a vehicle based on a difference between a position of a point corresponding to the object in the specific frame and a position of a point corresponding to the object in the second frame;
determining the moved distance based on a sum of a moved distance of the vehicle and the relative moved distance of the object; and
matching the point corresponding to the object in the specific frame to the point corresponding to the object in the second frame.

15. The method of claim 14, wherein the determining whether the moved distance of the object between the specific frame and the second frame after the specific frame is greater than the specified distance or whether the speed of the object is greater than the specified speed includes:
determining a center point contained in a most preceding line segment in a moving direction of the object among line segments constituting the object box as a point corresponding to the object, or
determining another point contained in the most preceding line segment as the point corresponding to the object.

16. The method of claim 11, wherein values, of the first axis coordinates of points included in the range, are included between:
a value of a first axis coordinate of a point corresponding to a vehicle and
a value of a second axis coordinate separated from the first axis coordinate of the point corresponding to the vehicle by a threshold distance in a direction of the first axis.

17. The method of claim 11, further comprising:
determining that a second axis coordinate of a point corresponding to the object is within a second axis range; and
assigning a second reliability value to the object based on at least one of:
the second axis coordinate being within the second axis range,
at least one of the minimum value of the first axis coordinates and the maximum value of the first axis coordinates being within the range,
the object being absent in the first frame,
all or part of the contour points being unobstructed by the another object,
the moved distance being greater than the specified distance, or
the speed of the object being greater than the specified speed.

18. The method of claim 11, further comprising:
determining whether a second axis coordinate of a point corresponding to the object is located in a second axis range including a specified number of lanes on both sides of a lane where a vehicle is located; and
assigning the reliability value to the object based on the second axis coordinate of the point corresponding to the object being located in the second axis range.

19. The method of claim 11, further comprising:
assigning, to the object, an identifier indicating that the object is moving or movable, based on determining that the object is moving or movable.

20. The method of claim 11, wherein the specified speed indicates a threshold value for determining whether the object is moving or movable, based on a minimum first axis coordinate value of the object or a maximum first axis coordinate value of the object being included in the range, and
wherein values of the first axis coordinates of points included in the range are included between:
a value of a first axis coordinate of a point corresponding to a vehicle and
a value of a second axis coordinate separated from the first axis coordinate of the point corresponding to the vehicle by a threshold distance in a direction of the first axis.
